(19) United States
(12) Patent Application Publication
(10) Pub. No.: US 2011/0011609 A1
(43) Pub. Date: Jan. 20, 2011

(54) AUXILIARY HANDLE AND HANDHELD POWER TOOL

(76) Inventors: Robert Simm, Oekingen (CH); Thomas Bannwart, Wiedlisbach (CH)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/921,280

(22) PCT Filed: Nov. 17, 2008
(86) PCT No.: PCT/EP08/65673

§ 371 Date: Sep. 7, 2010

(30) Foreign Application Priority Data
Mar. 5, 2008 (DE) 10 2008 000 516.9

(51) Int. Cl. B25F 5/02; B25D 17/04

(52) U.S. Cl. 173/171; 16/426

(57) ABSTRACT

The invention relates to an auxiliary handle which includes at least one fastening element for fastening the auxiliary handle to a hand-held power tool. In order to establish a direct or indirect form-locking connection between the auxiliary handle and the hand-held power tool, a spring element of the fastening element snaps into a recess of the hand-held power tool. The invention further relates to a hand-held power tool having such an auxiliary handle.

### PRIOR ART

The invention relates to an auxiliary handle for a handheld power tool as generically defined by the preamble to claim 1, and to a handheld power tool as defined by claim 9.

For easier manipulation of handheld power tools, such as power drills or rotary hammers, auxiliary handles are known that with the aid of a fastening means can be fixed as needed on the handheld power tool, usually on a spindle neck of the handheld power tool. Typically, the fastening means include a clamping ring with which a friction-locking connection can be made between the auxiliary handle and the handheld power tool.

Since in practice it can happen that the friction-locking connection between the auxiliary handle and the handheld power tool will come loose, an auxiliary handle 1 shown in FIG. 7 has been developed by Applicant as in-house prior art, which has not yet been made public. The auxiliary handle 1 includes fastening means 2, with which a form lock can be made in the axial direction of a handheld power tool 3. To that end, the fastening means 2 includes a riblike element 4, which can be received in a circumferential groove 5 in a spindle neck 6 of the handheld power tool 3. A disadvantage of the auxiliary handle 1 is that the user cannot always be sure whether the riblike element 4 is in fact received in the circumferential groove 5. If the rigid riblike element 4 is acted upon by force, as shown in FIG. 7, against the spindle neck 6 with axial spacing from the circumferential groove 5, then contact faces 7, 8 of the auxiliary handle 1, which are provided axially adjacent to the riblike element 4, do not come into contact with the handheld power tool 3, and no form lock between the auxiliary handle 1 and the handheld power tool 3 is achieved, with the consequence that the auxiliary handle 1, especially from vibration occurring during work with the handheld power tool 3, can unintentionally come loose from the handheld power tool 3.

### DISCLOSURE OF THE INVENTION TECHNICAL OBJECT

It is the object of the invention to propose a handle which can be secured against unintentionally coming loose from the handheld power tool. The object is also to propose a correspondingly optimized handheld power tool with an auxiliary handle.

### TECHNICAL ATTAINMENT OF THE OBJECT

This object is attained in terms of the auxiliary handle with the characteristics of claim 1 and in terms of the handheld power tool with the characteristics of claim 9. Advantageous refinements of the invention are recited in the dependent claims. All combinations of at least two of the characteristics disclosed in the specification, claims, and/or drawings, come within the scope of the invention.

The invention is based on the concept of embodying the at least one fastening means of the auxiliary handle in such a way that with it, a form-locking connection, which is operative in an axial direction, with the handheld power tool can be made, as a result of which efficient securing of the auxiliary handle in the axial direction can be attained. For instance if a tool bit becomes blocked in operation of the handheld power tool, slipping of the auxiliary handle in the axial direction can advantageously be avoided. It is preferable if the axial direction in which the form-locking connection is operative matches the working direction, that is, in a power drill, the drilling direction or drilling axis. So that the user can be sure that the axial form-locking connection between the auxiliary handle and the handheld power tool is made, it is provided, in an auxiliary handle embodied in accordance with the concept of the invention, that at least one fastening means of the auxiliary handle makes the form-locking connection with the handheld power tool, with the aid of a spring element that can be received in a recess of the handheld power tool. Preferably, the recess is a circumferentially extending groove on the outside of the handheld power tool, preferably a groove disposed on the outside of a spindle neck of the handheld power tool. The provision of a fastening means with a spring element that can be snapped into a recess in the handheld power tool has the advantage that the auxiliary handle can initially be disposed on the handheld power tool in such a way that the spring element does not yet snap into the recess associated with it, and in other words the spring element is disposed with axial spacing from the recess. By moving the auxiliary handle in the axial direction, preferably after prior prestressing of the spring element, the spring element automatically snaps into the recess of the handheld power tool, which is preferably indicated to the user by a clicking sound preferably generated by the impact of the spring element with the bottom of the recess. When the user hears a click, he knows that the spring element has been received in the recess.

Particularly to enable using the auxiliary handle with different handheld power tools, it is provided in a refinement of the invention that the spring element is displaceable and/or deformable relative to the handheld power tool at an angle, in particular perpendicularly, to the axial direction in which the form-locking connection is operative. Particularly by a deformable embodiment and disposition of the spring element, the spring element can adapt/conform to the contour of the circumference of the handheld power tool. A displacement of the spring element relative to the handheld power tool can be achieved by moving the handheld power tool, by actuation of the clamping device, in the direction of the spring element.

An embodiment in which in addition to a form-locking connection, acting in the axial direction, between the auxiliary handle and the handheld power tool a friction-locking connection can be attained between the auxiliary handle and the handheld power tool is especially advantageous. One possible way of attaining a friction-locking connection is for a recess, penetrated by the handheld power tool and in particular by a spindle neck of the handheld power tool, of the auxiliary handle to be embodied in two parts; the two parts of the recess, each in the form of a part of a circle, can be clamped to the handheld power tool, in particular to the spindle neck, with the aid of a screw connection. An embodiment in which a spindle is provided for that purpose and is disposed on the handle is preferable, the spindle being rotatable, for instance by rotating a part of the handle, as a result of which two clamping parts are displaced relative to one another. An embodiment in which at least one contact face, axially adjacent to the spring element, is provided that can be pressed against the outer circumference of the handheld power tool, in particular of the spindle neck, is especially advantageous. Preferably, such contact faces are provided on both axial sides of the spring element. To make it possible to establish a secure friction-locking connection between the auxiliary handle and a handheld power tool even if the handheld power tool has no fitting recess for receiving the spring element, or if the auxiliary handle is to be fixed on the handheld power tool in such a way that the spring element is disposed with axial spacing from the recess, it is advantageous if the spring element can spring back far enough that it does not protrude in the direction of the handheld power tool past the contact faces provided axially adjacent to the spring element, so that the contact faces can securely contact the outer circumference of the handheld power tool, and particularly the spindle neck, and as a result, the handheld power tool is clamped. An auxiliary handle embodied in this way can be used with handheld power tools in which a recess for receiving the spring element is provided, as well.

An alternative possibility for making a friction-locking connection is that the handheld power tool, in particular a spindle neck of the handheld power tool, is received in a contoured recess, in particular circular, of an (upper) component, and for making a clamped connection or a friction lock, the recess cross section is reduced by displacing the upper component in the direction into a (lower) component, or more precisely into a recess, open toward the top, in the lower component.

An embodiment of the auxiliary handle in which the spring element is shaped such that with it a multi-point contact, and preferably a three-point contact, on the handheld power tool can be achieved, preferably inside the recess of the handheld power tool, in the form of a support on a plurality of regions spaced apart circumferentially.

Axial loosening of the auxiliary handle from the power tool can be realized by providing that the spring element is embodied as a wire torsion spring. Sufficient securing can then be attained with a wire diameter of as little as about 1.2 mm. Preferably, the spring element embodied as a wire torsion spring extends transversely to the axial direction in which the form-locking connection is operative.

So that the spring element can be adequately braced in the axial direction on the auxiliary handle, it is preferred that the spring element be received in a slot in the auxiliary handle, and the spring element protrudes past the slot in the direction of the handheld power tool. Preferably, the slot penetrates a clamping device for displacing the spring element in the direction of the handheld power tool transverse to the axial direction in which the form-locking connection is operative.

For fixing the spring element inside the slot, various possibilities exist. With a view to easy assembly and a secure hold, an embodiment in which the spring element is snapped inside the slot, preferably by both free ends of the spring element, is preferred.

It is also provided that in addition to the fastening means that effect an axial form lock, at least one further fastening means is provided, with which a form-locking connection can be made between the auxiliary handle and the handheld power tool in a circumferential direction, or in other words preferably in a direction extending all the way around the axial direction. To attain a form lock in the circumferential direction, it is possible to provide at least one extension on the outer circumference of the handheld power tool, which extension cooperates with a recess in the auxiliary handle to prevent rotation in the circumferential direction. In addition or alternatively, an extension that cooperates with a recess on the handheld power tool to prevent rotation can be provided on the auxiliary handle. Preferably, a plurality of recesses and/or extensions, preferably distributed uniformly in the circumferential direction, are provided.

The invention, also leads to a handheld power tool having an auxiliary handle as described above.

Preferably, the handheld power tool has a recess which is embodied such that it can cooperate with the spring element, receiving the spring element, so that with the aid of the spring element, an axially operative form lock with the handheld power tool can be made, to secure the auxiliary handle against unintentional loosening in the axial direction from the handheld power tool. In addition to the axial securing between the auxiliary handle and the handheld power tool, advantageously between the auxiliary handle and a spindle neck of the handheld power tool, a friction-locking connection can preferably be made.

### BRIEF DESCRIPTION OF THE DRAWINGS

Further advantages, characteristics, and details of the invention will become apparent from the ensuing description of preferred embodiments and from the drawings. In the drawings:

FIG. 1 shows a handheld power tool with an auxiliary handle;

FIG. 2 shows one possible embodiment of a spindle neck of the handheld power tool of FIG. 1;

FIG. 3 is a partial section through an auxiliary handle;

FIG. 4 is a perspective view of an auxiliary handle;

FIG. 5 is a longitudinal sectional view of the auxiliary handle of FIG. 4;

FIG. 6 shows one possible embodiment of a spring element, embodied differently from the exemplary embodiment of FIG. 3; and

FIG. 7 shows an auxiliary handle in the in-house prior art;

FIG. 8 is a fragmentary section through a further exemplary embodiment of an auxiliary handle of the invention.

### EMBODIMENTS OF THE INVENTION

In the drawings, identical components and components having the same connection are identified by the same reference numerals.

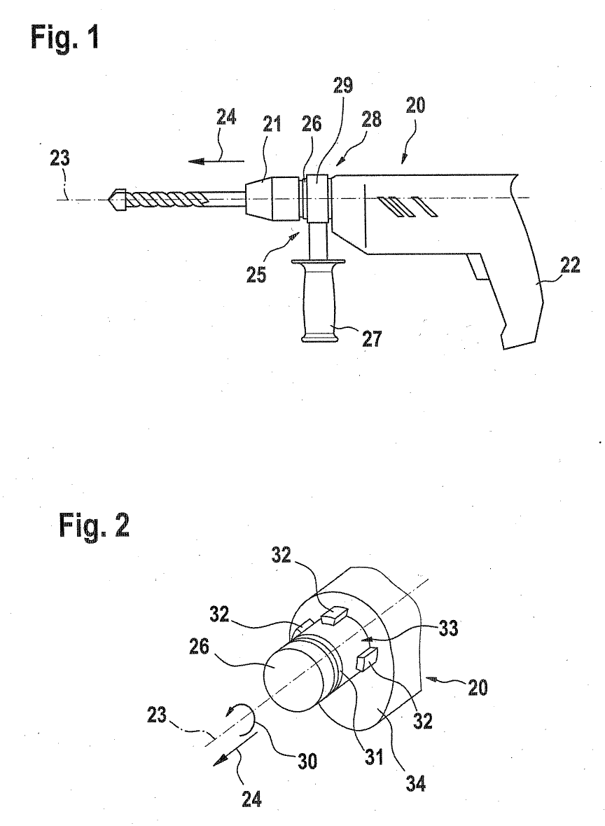

In FIG. 1, a handheld power tool 20 is shown, embodied as a power drill and/or power impact drill. The handheld power tool 20 includes a tool receptacle 21, which can be driven via a drive unit, not further shown. The handheld power tool 20 furthermore includes a main handle 22, disposed on a side of the handheld power tool 20 remote from the tool receptacle 21. Along a work axis 23 (drilling axis in this case), an auxiliary handle 25 is disposed in the axial direction 24 upstream of the tool receptacle 21. The auxiliary handle 25 is located on a spindle neck 26 of the handheld power tool 20. The auxiliary handle 25 has what in the plane of the drawing are a lower handle portion 27 and a fastening portion 28 disposed above it. The fastening portion 28 has a handheld power tool receptacle 29, which is penetrated in the axial direction 24 by the handheld power tool 20, in this case by the spindle neck 26. The handheld power tool receptacle 29 is connected by friction locking to the spindle neck 26.

In FIG. 2, a detail of the handheld power tool 20 shown in FIG. 1 is shown in a view obliquely from the front, with its spindle neck 26 for receiving the auxiliary handle 25. The spindle neck 26 has a cylindrical shape and is oriented along the work axis 23 of the handheld power tool 20. A recess 31 embodied as a groove (circumferential groove) extending all the way around in a circumferential direction 30 is made in the spindle neck 26 and is embodied for direct cooperation with a spring element to be described in further detail hereinafter. By cooperation of the spring element with the recess 31, the auxiliary handle 29 can be secured against an intentional loosening in the axial direction 24 along the work axis 23.

Four riblike protrusions 32 are also provided on the rear end of the spindle neck 26 and are distributed in the circumferential direction 30 around the spindle neck 26. The four riblike protrusions 32 are disposed uniformly relative to one another in the circumferential direction 30, or in other words at a spacing of 90° each, and are embodied in one piece with the spindle neck 26. Moreover, the four riblike protrusions 32 are disposed on a peripheral region 33, facing away from the tool receptacle 21, of the spindle neck 26, which region adjoins a housing 34 of the handheld power tool 20. The radially extending riblike protrusions 32 serve to cooperate with fastening means, to be described hereinafter, for attaining a form-locking connection in the circumferential direction 30 between the auxiliary handle 25 and the handheld power tool 20.

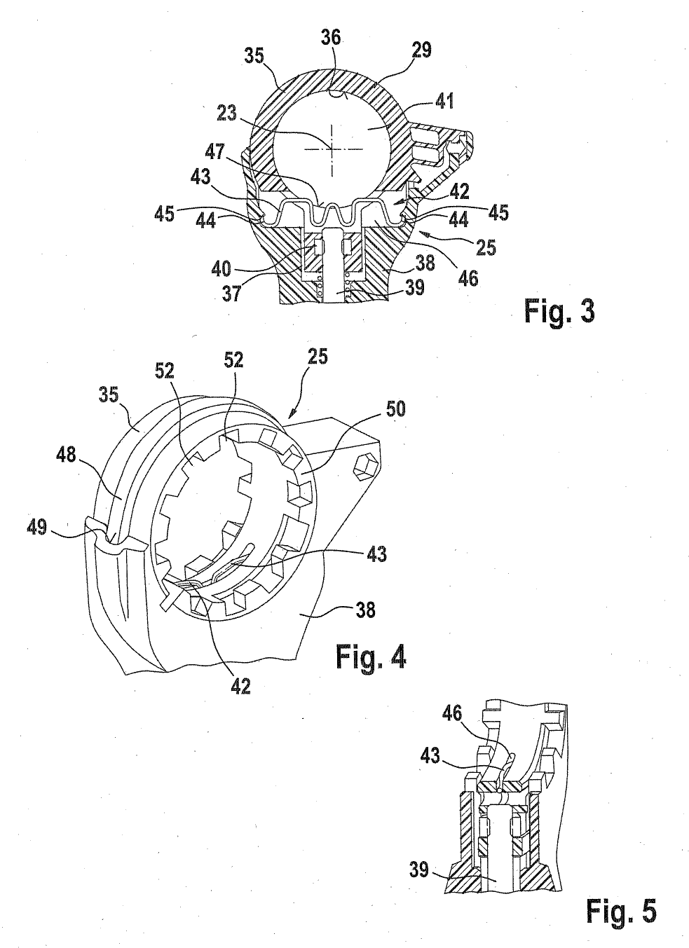

In FIG. 3, one possible embodiment of an auxiliary handle 25 is shown. The fastening portion 28 with the handheld power tool receptacle 29, in the exemplary embodiment shown, is embodied in two parts. It includes an upper component 35 with a circular inner contour 36 (the actual receiving opening for the spindle neck 26). The upper part 35 is received in a recess 37 in a lower component 38. The grip portion 27 (see FIG. 1) for grasping the auxiliary handle 25 is embodied on the lower portion, not shown, of the lower component 38. The grip portion 27 is penetrated by a threaded spindle 39, which engages a threaded nut 40, which in turn is fixed in the upper part 35 in a manner fixed against relative rotation. By twisting the threaded spindle 39, which is fixed in a manner fixed against relative rotation on the lower, separate portion of the grip portion 27, the upper component 35 can be displaced perpendicularly to the work axis 23 relative to the lower part 38 and relative to the grip portion, not shown. As a result, the free cross section 41 (receiving cross section) enclosed by the handheld power tool receptacle 29 can be varied, and as a result, a friction-locking connection can be made between the auxiliary handle 25 and the handheld power tool 20.

The auxiliary handle 25 includes a fastening means 42 for making a form-locking connection in the axial direction 24, shown in FIGS. 1 and 2, between the auxiliary handle 25 and the handheld power tool 20. The fastening means 42 includes a spring element 43, embodied as a wire torsion spring with a diameter of 1.2 mm, which is disposed in a plane that is penetrated at a right angle by the work axis 23 and the axial direction 24. The spring element 43 is snapped with its free ends 44 behind a respective protrusion 45 of the lower component 38. The spring element 43 is received in a slot 46 (gap), which extends transversely to the axial direction 24 and to the work axis 23. The slot 46 is formed jointly by the upper component 35 and the lower component 38. By displacing the upper component 35 in the direction of the lower component 38, the spindle neck 25 received in the handheld power tool receptacle 29 is moved in the direction of the spring element 43, which as a result is acted upon by a force F. The arrows for the force F point to three regions of the spring element 43, with which regions the spring element 43 makes a three-point contact with the handheld power tool 20. If the auxiliary handle 25 is fixed on the handheld power tool 20 in such a manner that the spring element 43 can yield into the groovelike recess 31 perpendicularly to the work axis 23, then the auxiliary handle 25 is secured against axial shifting in the axial direction 24 on the handheld power tool 20. If the auxiliary handle 25 is first brought to the handheld power tool 20 in such a way that the spring element 43 comes to rest on the spindle neck 26 with axial spacing from the recess 31, and if the upper component 35 is displaced so far in the direction of the lower component 38 that axial shifting of the auxiliary handle 25 relative to the handheld power tool 20 is still possible, then the spring element 43, upon axial displacement of the auxiliary handle 25 toward the handheld power tool 20, can yield into the recess 31 as soon as the spring element is located at the axial level of the recess 31. This snapping action is signaled to the user by a clicking noise.

If the auxiliary handle 25 is fixed on a handheld power tool 20 without a recess 31 or in spaced-apart fashion from the recess 31, then the spring element 43 has enough spring play in the direction of the grip portion 27 that it can spring back again, in such a way that it does not protrude in the direction of the handheld power tool 20 past a contact face 47, provided axially adjacent to the spring element 43, for direct contact with the handheld power tool 20, in order as a result to be able to guarantee a secure friction-locking hold of the auxiliary handle 25 on the handheld power tool 20.

The friction-locking connection between the auxiliary handle 25 and the handheld power tool 20 can be ensured in some other way, for instance by embodying the handheld power tool receptacle 29 in slotted form and moving the free ends, facing one another, of the handheld power tool receptacle 29 toward one another, for instance by means of a screw connection to be mounted laterally. What is essential is that means for varying the free cross section 41 are provided.

The spring element 43 is embodied symmetrically to a mirror plane in which the work axis 23 is received and which extends longitudinally of the handheld power tool 20. In a middle region, the spring element 43 is shaped like a W and then merges on both sides with a respective cross section which then merges, via an oblique portion, with the respective curved, locked free end 44.

In FIGS. 4 and 5, an alternative exemplary embodiment of the auxiliary handle 25 is shown. To avoid repetition, for common features with the exemplary embodiment of FIG. 3, see the foregoing description of the drawings.

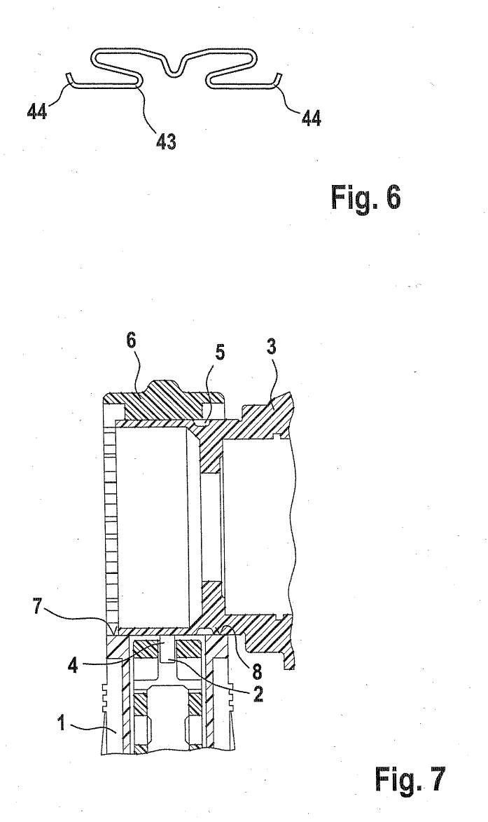

In FIG. 3, the upper component 35 can be seen, which is displaceable relative to the lower component 38 with the aid of the threaded spindle 39 shown in FIG. 5. The slot 46 in which the spring element 43 is received can be seen. The spring element 43 is embodied as shown in FIG. 6. Once again this is a spring element 43 which is embodied as a wire torsion spring and is embodied symmetrically to a plane of symmetry. With the spring element 43 shown, a two-point contact can be made with two oblique portions. In a central portion, the spring element 43 has a curved portion (approximately V-shaped) pointing away from the handheld power tool 20, and this portion merges at both sides with an S-shaped portion, on each of which one free end 44 is embodied.

In FIG. 4, a circumferential bead 48 can be seen on the upper component 35; with this bead, the upper component 35 is guided in a corresponding guide groove 49 on the lower component 38.

In addition to the fastening means 42 having the spring element 43, a further fastening means 50 is provided for making a form-locking connection with the handheld power tool 20 in the circumferential direction 30. To that end, the fastening means 50 has many peripheral recesses 52, distributed uniformly in the circumferential direction, which are embodied for cooperation with the protrusions 32 on the handheld power tool 20. Because recesses 52 are provided on both axial face ends of the handheld power tool receptacle 29, the auxiliary handle 25 can be connected in form-locking fashion with the handheld power tool 20 in the circumferential direction in two assembly directions.

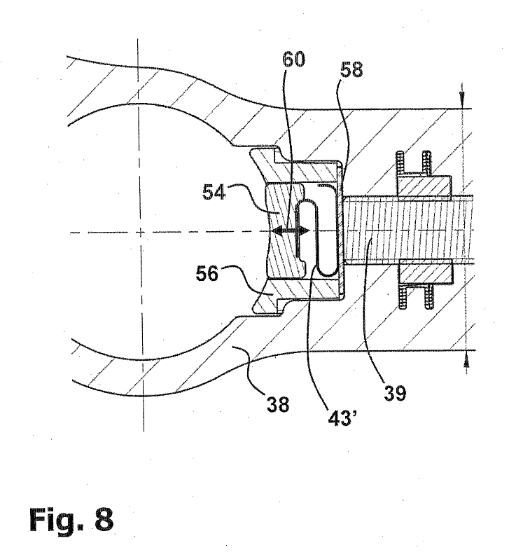

FIG. 8 shows a fragmentary partial section through a further exemplary embodiment of an auxiliary handle 25 of the invention. Features that are identical or function identically are identified by the same reference numerals as in the exemplary embodiments described above. In this exemplary embodiment, the fastening region 28 where the auxiliary handle 25 of the invention is fastened to the handheld power tool receptacle 29 is embodied in one piece.

The embodiment of FIG. 8 differs from the already known embodiments of the auxiliary handle 25 of the invention in having a movable closing element 54. The movable closing element 54 is disposed on the end region of a spring element 43′, which region is oriented toward the work axis 23. The spring element 43′ is preferably embodied as a folded leaf or band spring. However, other helical springs and/or other pressure elements, for example of elastomers or other elastic materials, can also be used as the spring element 43′. The closing element 54, in the present example, is disposed in particular axially displaceably in the auxiliary handle 25 along a direction of motion 60. The spring element 43′ exerts a detent force, oriented in the direction of motion 60, on the closing element 54. In an assembled state, not shown here, of the auxiliary handle 25 of FIG. 8, the closing element 54 is locked in the recess 31 of the handheld power tool 20 by the spring element 43′. In this way, the spring element 43′ brings about an indirect form-locking connection between the auxiliary handle 25 and the handheld power tool 20. The term “indirectly form-locking” is understood in particular to mean that for making the form-locking connection between the closing element 54 of the auxiliary handle 25 and the handheld power tool 20, the spring element 43 must contribute the necessary force component.

The spring element 43′, in the version of FIG. 8, is disposed on a support element 58, on a side remote from the closing element 54. The support element 58 is provided between the spring element 43′ and the end, oriented toward the spring element 43′, of the threaded spindle 39. The support element 58 decouples the spring element 43′ from a rotary motion of the threaded spindle 39 that occurs upon a displacement of the auxiliary handle 25. In alternative versions, which instead of the threaded spindle 39 for instance use a clamping wedge or other wedging device, under some circumstances the support element 58 can also be dispensed with.

In the version of FIG. 8, the closing element 54 and the spring element 43′ are received in a guide element 56. In the present example, the guide element 56 is again received displaceably in the direction of motion 60 in the lower component 38 of the auxiliary handle 35 and is disposed on the support element 58. On the ends oriented toward the work axis 23, the guide element 56, in the embodiment of FIG. 8, is equipped with one locking vane each. If the threaded spindle 39 is closed in the direction toward the work axis 23, then these locking vanes reinforce the detent action of the closing element 54. In alternative versions, this action can be dispensed with by dispensing with the locking vanes and/or not embodying the guide element 56 displaceably and/or not disposing it on the support element 58.

Further advantageous embodiments of an auxiliary handle 25 of the invention can be attained by combinations of the characteristics described above.

1-14. (canceled)

15. An auxiliary handle comprising at least one fastening means for fixing the auxiliary handle to a handheld power tool, the fastening means having at least one spring element, which to attain a form-locking connection or indirect form-locking connection between the auxiliary handle and the handheld power tool, the at least one spring element is embodied and disposed in a manner such that the at least one spring element is snapped into a recess in the handheld power tool.

16. The auxiliary handle as defined by claim 15, further comprising a movable closing element, which is loaded by the spring element in such a way that the closing element makes a form-locking connection between the auxiliary handle and the handheld power tool, as a result of the fact that the closing element is capable of being snapped into the recess of the handheld power tool.

17. The auxiliary handle as defined by claim 16, wherein the spring element is disposed on a movable support element on a side of the spring element remote from the recess.

18. The auxiliary handle as defined by claim 16, wherein the movable closing element is received in a guide element and is guided essentially in a direction of motion of the closing element.

19. The auxiliary handle as defined by claim 17, wherein the movable closing element is received in a guide element and is guided essentially in a direction of motion of the closing element.

20. The auxiliary handle as defined by claim 18, wherein the guide element is likewise disposed on the movable support element and can be moved by the guide element in the direction of motion.

21. The auxiliary handle as defined by claim 19, wherein the guide element is likewise disposed on the movable support element and can be moved by the guide element in the direction of motion.

22. The auxiliary handle as defined by claim 15, wherein the spring element is displaceable and/or deformable relative to the handheld power tool perpendicularly to an axial direction by means of a clamping device that is displaceable at an angle, in particular perpendicularly, to the axial direction.

23. The auxiliary handle as defined by claim 18, wherein the spring element is displaceable and/or deformable relative to the handheld power tool perpendicularly to an axial direction by means of a clamping device that is displaceable at an angle, in particular perpendicularly, to the axial direction.

24. The auxiliary handle as defined by claim 19, wherein the spring element is displaceable and/or deformable relative to the handheld power tool perpendicularly to an axial direction by means of a clamping device that is displaceable at an angle, in particular perpendicularly, to the axial direction.

25. The auxiliary handle as defined by claim 20, wherein the spring element is displaceable and/or deformable relative to the handheld power tool perpendicularly to an axial direction by means of a clamping device that is displaceable at an angle, in particular perpendicularly, to the axial direction.

26. The auxiliary handle as defined by claim 21, wherein the spring element is displaceable and/or deformable relative to the handheld power tool perpendicularly to an axial direction by means of a clamping device that is displaceable at an angle, in particular perpendicularly, to the axial direction.

27. The auxiliary handle as defined by claim 22, further comprising at least one contact face, disposed axially adjacent to the spring element, for contact with the handheld power tool, wherein the spring element is embodied and disposed resiliently at least so far in a direction away from the handheld power tool that does not protrude past the contact face in the direction of the handheld power tool.

28. The auxiliary handle as defined by claim 15, wherein the spring element is shaped such that with it, a multi-point contact, preferably a three-point contact, on the handheld power tool, preferably inside the recess of the handheld power tool, can be attained.

29. The auxiliary handle as defined by claim 15, wherein the spring element is embodied as a wire torsion spring.

30. The auxiliary handle as defined by claim 15, wherein the spring element is received in a slot in the auxiliary handle, which slot is preferably located in a plane penetrated at a right angle by the axial direction.

31. The auxiliary handle as defined by claim 30, wherein the spring element is snapped, preferably inside the slot.

32. The auxiliary handle as defined by claim 15, further comprising a fastening means for attaining a form-locking connection in a circumferential direction.

33. A handheld power tool having an auxiliary handle as defined by claim 15.

34. The handheld power tool as defined by claim 33, wherein the handheld power tool has a recess, cooperating with the spring element, the recess extending in a circumferential direction and preferably disposed on a spindle neck of the handheld power tool.
